(19) United States
(12) Patent Application Publication
(10) Pub. No.: US 2024/0011814 A1
(43) Pub. Date: Jan. 11, 2024

(54) FUNCTIONAL INTERFACE FOR PROVIDING A FUNCTION ACCORDING TO SENSOR MEASUREMENT VALUES, AND SENSOR FOR PROVIDING MEASUREMENT VALUES TO A FUNCTIONAL INTERFACE

(71) Applicant: VEGA Grieshaber KG, Wolfach (DE)

(72) Inventors: Florian Krämer, Mühlenbach (DE); Patrick Heizmann, Oberwolfach (DE); Stefan Allgaier, Oberwolfach (DE)

(21) Appl. No.: 18/251,619

(22) PCT Filed: Nov. 10, 2020
(86) PCT No.: PCT/EP2020/081676

§ 371 Date: May 3, 2023

(51) Int. Cl. G01F 23/284

(52) U.S. Cl. CPC G01F 23/284

(57) ABSTRACT

The invention relates to an electronic function interface for a sensor for detecting a measured quantity, the electronic function interface providing at least one predetermined function depending on sensor information and/or measurement values of the measured quantity detected by the sensor, wherein the function interface is configured as a unit that is constructionally independent of and segregable from the sensor and is coupled to the sensor in a wirelessly data-transmitting manner. The invention further relates to an electronic sensor for detecting a measured quantity, which cooperates with at least one constructionally independent electronic function interface in this manner, and the assembly of an electronic function interface and sensor that are coupled in such a manner.

The invention relates to an electronic function interface for providing a predetermined function depending on sensor information and/or measurement values of an electronic sensor for detecting a measured quantity. The invention further relates to an electronic sensor for detecting a measured quantity, which provides the measurement values of the detected measured quantity to an electronic function interface for providing a predetermined function depending on sensor information and/or measurement values. Moreover, the invention relates to an assembly of an electronic sensor for detecting a measured quantity and an electronic function interface for providing a predetermined function depending on sensor information and/or measurement values regarding the measured quantity provided by the sensor.

Electronic function interfaces connected to electronic sensors, which provide a certain function, e.g. current or voltage signals via a current or voltage output terminal, depending on measurement values of a measured quantity detected by the sensors, are known as such. In this case, the function interface may be considered an interface for converting the electric measurement signals generated by the sensor into electric function signals preferred for a specific application.

A predetermined fixed, stationary configuration, e.g. in the form of a mechanical connection, between such sensors and function interfaces is advantageous in that no subsequent assignment between the two components corresponding to the respective individual application needs to be carried out, which may simplify an installation effort for sensor(s) and function interface(s) on-site. However, such a rigid assignment between the sensor and the function interface also considerably lacks flexibility, particularly if the function provided by the function interface is not directly required at all at the site of the measurement value recording carried out by the sensor, for example.

Against this background, the invention is based on the object of providing an electronic function interface for providing a predetermined function depending on the sensor information and/or measurement values of the sensor, which can be coupled to an electronic sensor for detecting a measured quantity, an electronic sensor for detecting a measured quantity, which can be coupled to an electronic function interface for providing a predetermined function depending on the sensor information and/or sensor measurement values, and an assembly consisting of such a function interface and such a sensor, which can be adapted with little effort as regards material and installation to different operating conditions and requirements in a time-saving and cost-effective manner. They are supposed to have a high level of flexibility with respect to various purposes of use. Moreover, even a subsequent (functional) extension of already existing measuring systems is to be made possible without requiring a large expenditure in terms of time, material, assembly and costs.

This object is achieved by means of an electronic function interface having the features of claim 1, an electronic sensor having the features of claim 10, and by an assembly consisting of an electronic function interface and an electronic sensor having the features of claim 18. Other particularly advantageous embodiments of the invention are disclosed by the respective dependent claims.

It must be noted that the features cited individually in the claims can be combined with each other in any technologically meaningful manner (also across the boundaries of categories, such as method and device) and represent other embodiments of the invention. The description, in particular in connection with the Figures, additionally characterizes and specifies the invention.

It may also be noted that “and/or” used hereinafter, which is situated between two features and links them to each other, should always be interpreted such that, in a first embodiment of the subject matter according to the invention, only the first feature may be provided, in a second embodiment, only the second feature may be provided, and in a third embodiment, both the first and the second feature may be provided.

An electronic function interface according to the invention for providing at least one predetermined function depending on sensor information (in particular sensor-related information, such as, for example, type of sensor, type of measured quantity, measurement range, reliability of measurement, amplitude, frequency etc.) and/or measurement values of a measured quantity, e.g. a filling level, limit level, pressure or viscosity, detected by an electronic sensor, e.g. sensor types such as radar sensor, microwave sensor, pressure sensor and the like, cooperates with this sensor. In this regard, it is necessary for the sensor of the function interface to provide at least information on the measurement values detected by it, so that the function interface can provide the predetermined function accordingly. It may be mentioned that the information does not necessarily have to be provided directly between the function interface and the respective sensor, but that this may also take place via an interposed device. For example, the sensor may provide the measurement value information to the interposed device, with the interposed device forwarding this information to the function interface.

According to the invention, the function interface is configured as a unit that is constructionally independent and segregable—in particular, detachable, separable, modular, replaceable—from the sensor, and is additionally coupled to the sensor in a wirelessly data-transmitting manner. Thus, the function interface can be positioned completely independently of the sensor, since the function interface is not an integral constituent of the sensor or vice versa. Thus, the function interface may be arranged at a distance from the measurement site of the sensor, e.g. preferably a few meters, or even more than ten, more than a hundred, or more than a thousand meters, where the function provided by the function interface is actually needed. The function interface being independent of the sensor and vice versa considerably increases the flexibility and the degree of freedom in selecting possible scenarios of use. Unlike the wiring/cabling of the function interface and the sensor, the installation and time requirements for building an interface-sensor assembly according to the invention are substantially completely independent of the actual distance between the function interface and the sensor.

If, in existent measuring systems, measuring sensors are also already configured for providing their measurement values to a function interface according to the invention in a wirelessly transmitting manner, such measuring systems can also be subsequently expanded with the function interface according to the invention, whereby the range of functions of the existing measuring system can be expanded without requiring much material, assembly, costs and the like.

According to a preferred development of the subject matter of the invention, the function interface has at least one switch output terminal (e.g. a relay output terminal), current output terminal, voltage output terminal and/or a communications module providing the predetermined function. In the case of the switch output terminal, the function interface can generate one or several predetermined switching states depending on the sensor measurement values it is provided with. Current and/or voltage signals representing the measurement values of the sensor at a predefined strength/level, for example, may be outputted on one or several current or voltage output terminals of the function interface. A communications module may generate, depending on sensor information and/or the sensor measurement value, predefined notifications and transmit them accordingly in a wireless or wired manner. For example, informative notifications or alarms may be transmitted when a certain limit or filling level of a medium is reached (event-based transmission). As an alternative for or in addition to the sensor measurement values, other sensor information, such as, for example, reliability of measurement, amplitude, frequency, etc., may also be used as the basis for controlling the segregated function interfaces. For example, a switching of the antenna purging in the event of a detection of deposits or a drop in the reliability of measurement or amplitude can thus be realized. Alternatively or additionally, a continuous transmission, or one that takes place in predetermined regular time intervals, of sensor measurement values by means of the communications module may also be provided. For example, the predetermined function may be individually configured on the function interface itself, via radio or the cloud (e.g. limit values, actions, assignments, etc.).

For example, a 4-20 mA output terminal may be provided as a current output terminal, and a 0-10 V output terminal, for example, as a voltage output terminal. Communications modules may be field buses, wireless radio transmission devices or optical transmission devices.

Another advantageous embodiment of the invention provides that the function interface has at least one electric energy storage unit and/or an electric energy supply device and/or an electric energy generator providing a current supply of the function interface. Thus, the energy storage unit may be a battery or a rechargeable battery. An energy generator preferably may be a so-called energy harvesting device configured for obtaining comparatively small electrical energy quantities from sources present on the site of operation of the function interface, such as from the ambient temperature, electromagnetic radiation (including light), vibrations or air flows, for example. If the energy storage unit is configured as a rechargeable energy storage unit (rechargeable battery), the excess energy, which is provided by the energy generator and currently not required for the operation of the function interface, may be stored/buffered therein and used for operating the function interface at a later point in time (for example, when the energy source used for generating energy temporarily does not supply any energy). Alternatively or additionally, a rechargeable battery may also be charged via the electric energy supply device, wherein the latter may be configured as a wired supply device or wireless supply device (e.g. based on electromagnetic induction).

Accordingly, the energy supply device may have a wired coupling, which transmits electric energy, for a current feed from outside the function interface (e.g. by means of a plug and socket), and/or a wireless coupling (e.g. induction), which transmits electric energy, for a current feed from outside the function interface, whereas the energy generating device causes a current generation and current feed into the energy storage unit internal to the function interface.

On the whole, the above-described provision of energy enables an operation of the function interface that is self-sufficient for at least a certain period of time, whereby service intervals (e.g. for battery replacement) may at least be considerably reduced or even completely dispensed with during a scheduled deployment.

According to another embodiment of the invention, the function interface can be activated in a permanent or cyclic (interval-controlled) or event-based manner. The event-based control may be based on manual input (e.g. by a user) or take place automatically when a predetermined event (e.g. a freely definable filling level, limit level etc.) occurs. In the activated state, the function interface provides, as intended, the at least one function, whereas the function interface consumes no electric energy in its alternative inactive operating mode, so that a self-sufficient interface operation supplied by battery or rechargeable battery can be realized over very long periods of time (at least for some days or weeks, or even for months up to some years).

According to another advantageous embodiment of the invention, the wireless data transmission is configured as an exclusively unidirectional data transmission from the sensor to the function interface. In other words, the function interface is in this case configured only for receiving data on the measurement values detected by the sensor.

Alternatively, the wireless data transmission can be configured as a bidirectional data transmission between the sensor and the function interface, which means that the function interface can also wirelessly send back data/information via the same way it receives the measurement value information of the sensor. For example, this information may include an operational status of the function interface, e.g. an imminently required battery replacement or a defect on an interface component (e.g. the current/voltage/communications output terminal) or the like.

According to another development of the subject matter of the invention, the wireless data transmission is configured as a direct data transmission between the sensor and the function interface and/or is configured as an indirect data transmission between the sensor and the function interface routed via at least one interposed device that is external to the function interface and external to the sensor. In the case of direct data transmission, communication takes place directly between the sensor and the function interface, wherein radio standards such as (low-energy) Bluetooth, WLAN, LoraWan, NB-IoT etc. can be used.

In the case of the data transmission taking place by means of an interposed device, the interposed device may be a data/monitoring/control server of a measuring site control level, for example, or a global, decentralized storage device, which is known to be referred to as a “cloud”. That means that the sensor in this case does not itself transmit the measurement values directly to the function interface, but to the interposed device, which then forwards the measurement values to the function interface and, in the case of a bidirectional wireless data transmission of the function interface, can also receive data/information from the function interface. Because a wireless communication link of the sensor and the function interface in this case is required to exist only with the interposed device, the distance between the sensor and the assigned function interface may substantially be selected to be arbitrarily large, which again increases the flexibility of application considerably. The data transmission between the sensor or the function interface and the interposed device may take place via (low-energy) Bluetooth, WLAN, LoraWan, NB-IoT etc., for example, or via other correspondingly suitable transmission standards.

According to another aspect of the invention, an electronic sensor, e.g. sensor types such as radar sensor, microwave sensor, pressure sensor or the like, for detecting a measured quantity, e.g. a filling level, limit level, pressure or viscosity, cooperates with at least one electronic function interface for providing at least one predetermined function depending on sensor information (in particular sensor-related information, such as, for example, type of sensor, type of measured quantity, measurement range, reliability of measurement, amplitude, frequency etc.) and/or measurement values of the measured quantity detected by the sensor. In other words, the sensor provides the function interface with at least information on the measurement values detected by it, so that the function interface can provide the predetermined function accordingly. It is to be understood that the information does not necessarily have to be provided directly between the sensor and the function interface. It may also be provided via an interposed device. For example, the sensor may provide the measurement value information to the interposed device, with the interposed device forwarding this information to the function interface.

According to the invention, the sensor is configured as a unit that is constructionally independent and segregable—in particular, detachable, separable, modular, replaceable—from the function interface, and is coupled to the function interface in a wirelessly data-transmitting manner. Accordingly, the sensor can be positioned completely independently of the function interface, since the sensor is not an integral constituent of the function interface or vice versa. Thus, measurement site of the sensor may be disposed at a distance from the function interface, e.g. preferably a few meters, or even more than ten, more than a hundred, or more than a thousand meters. The function interface may provide its function at another location. The function interface being independent of the sensor and vice versa considerably increases the flexibility and the degree of freedom in selecting possible scenarios of use. Unlike the wiring/cabling of the function interface and the sensor, for example, the installation and time requirements for building a sensorinterface assembly according to the invention are substantially completely independent of the actual distance between the sensor and the function interface.

It is noted that, with regard to sensor-related definitions of terms and the effects and advantages of features of the sensor, reference is made in full to the disclosure of corresponding definitions, effects and advantages of the function interface according to the invention. Accordingly, disclosures contained herein regarding the function interface according to the invention may also be used, mutatis mutandis, for defining the sensor according to the invention unless expressly excluded herein. Also, disclosures contained herein regarding the sensor according to the invention may also be used, mutatis mutandis, for defining the function interface according to the invention. Thus, a repetition of explanations of features that are basically the same, their effects and advantages with regard to the sensor according to the invention and the function interface according to the invention may be omitted herein for the sake of a more compact description, without such omissions having to be interpreted as limitations.

Preferably, the sensor is configured as an energy self-sufficient sensor, i.e. equipped with its own energy supply, e.g. in the form of a battery or rechargeable battery.

An advantageous embodiment of the invention provides that the sensor has a holding device to which the function interface can be attached, which is to be understood to mean, in particular, a detachable attachment. In any case, the sensor and the function interface do not form an integral, non-detachable unit in the sense of the invention, despite the attachment option. Depending on the application, the sensor may thus be equipped with a preferred interface module.

According to an advantageous development of the subject matter of the invention, the sensor has a coupling means, which transmits electric energy and provides a current supply for the function interface attached to the holding device. This enables the function interface to be supplied with current via the current supply of the sensor. In this case, the function interface could dispense with its own current supply, e.g. by means of a battery, which simplifies construction and reduces the production costs.

Another advantageous embodiment of the invention provides that the coupling means transmitting energy is configured as a means coupling the function interface in a wired manner (e.g. in the form of a plug and socket) or in a wireless manner (e.g. inductively).

Furthermore, according to another embodiment, the wireless data transmission may be configured as an exclusively unidirectional data transmission from the sensor to the function interface. That is, the function interface is able only to receive the measurement value data provided by the sensor.

In an alternative embodiment, the wireless data transmission may be configured as a bidirectional data transmission between the sensor and the function interface. Thus, the function interface is able in this case to send data itself, e.g. information on its operational status, as was already explained herein in connection with the function interface according to the invention.

According to another embodiment of the invention, the wireless data transmission is configured as a direct data transmission between the sensor and the function interface and/or is configured as an indirect data transmission between the sensor and the function interface routed via at least one interposed device that is external to the sensor and external to the function interface.

In the case of direct data transmission, communication takes place directly between the sensor and the function interface, wherein radio standards such as (low-energy) Bluetooth, WLAN, LoraWan, NB-IoT etc. can be used.

In the case of the data transmission taking place by means of an interposed device, the interposed device may be a data/monitoring/control server of a measuring site control level, for example, or a global, decentralized storage device, which is known to be referred to as a “cloud”. Accordingly, the sensor in this case does not itself transmit the measurement values directly to the function interface, but to the interposed device, which then forwards the measurement values to the function interface and, in the case of a bidirectional wireless data transmission of the function interface, can also receive data/information from the function interface. The distance between the sensor and the function interface may be set without limits and in accordance with the requirements. The data transmission between the sensor or the function interface and the interposed device may take place via (low-energy) Bluetooth, WLAN, LoraWan, NB-IoT etc., for example, or via other correspondingly suitable transmission standards.

According to a preferred embodiment, the sensor may be a limit level sensor or a filling level sensor or a pressure sensor, without having to be limited thereto.

According to yet another aspect of the invention, an assembly, particularly a sensor-function interface assembly, has at least one electronic sensor according to any one of the embodiments disclosed herein and at least one electronic function interface according to any one of the embodiments disclosed herein. In this case, the function interface is configured as a unit that is constructionally independent and segregable—in particular, detachable, separable, modular, replaceable—from the sensor, and is coupled to the sensor in a wirelessly data-transmitting manner.

Also with regard to the assembly according to the invention of the sensor and the function interface, it is noted that, with regard to assembly-related definitions of terms and the effects and advantages of features of the assembly, reference is made in full to the disclosure of corresponding definitions, effects and advantages of the function interface according to the invention and sensor according to the invention. Accordingly, disclosures contained herein regarding the function interface according to the invention and the sensor according to the invention may also be used, mutatis mutandis, for defining the assembly according to the invention unless expressly excluded herein. Also, disclosures contained herein regarding the assembly according to the invention may also be used, mutatis mutandis, for defining the function interface according to the invention and the sensor according to the invention. A repetition of explanations of features that are basically the same, their effects and advantages with regard to the sensor according to the invention, the function interface according to the invention and the assembly according to the invention may be omitted herein for the sake of a more compact description, without such omissions having to be interpreted as limitations.

According to an advantageous embodiment of the assembly according to the invention, several sensors are provided, which are jointly coupled to one and the same function interface in the wirelessly data-transmitting manner, wherein the function interface provides the at least one predetermined function depending on the sensor information and/or the measurement values of the measured quantities respectively detected by the sensors. In other words, the several sensors assigned to the same function interface constitute a sensor group.

Another advantageous development of the subject matter of the invention provides for several function interfaces, which are jointly coupled to one and the same sensor in the wirelessly data-transmitting manner, wherein the function interfaces respectively provide the at least one predetermined function depending on the sensor information and/or the measurement values of the measured quantity detected by the sensor. The function interfaces assigned to the same senor form a function interface group.

A configuration required for assigning the sensor and the function interface may be carried out on the function interface on-site. For this purpose, the function interface may have corresponding input and/or output means, e.g. keys, a display, a touchscreen and the like. Configuration may also take place using a configuring device, which is not a part of the function interface, but is merely connected for the configuration process to the function interface via a corresponding configuration interface. Moreover, configuration may also take place wirelessly via a radio transmission. It is also conceivable to pre-configure the function interface prior to its installation in a measuring system, i.e. to predefine an assignment between the sensor(s) and the function interface(s), a sensor group or interface group, by storing corresponding field device addresses. If necessary, an additional or subsequent (re)configuration may also be carried out on-site or via radio.

Other advantages and features of the invention become apparent from the following description of exemplary embodiments of the invention, which shall be understood not to be limiting and which will be explained below with reference to the drawing. In this drawing, the Figures schematically show:

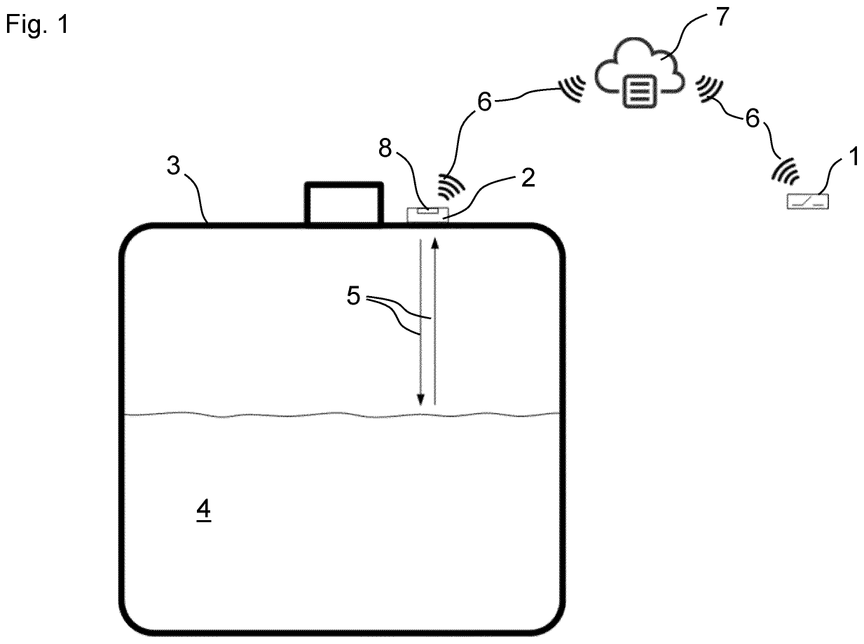

FIG. 1 a first example of use of an exemplary embodiment of, in each case, one function interface and one sensor according to the invention,

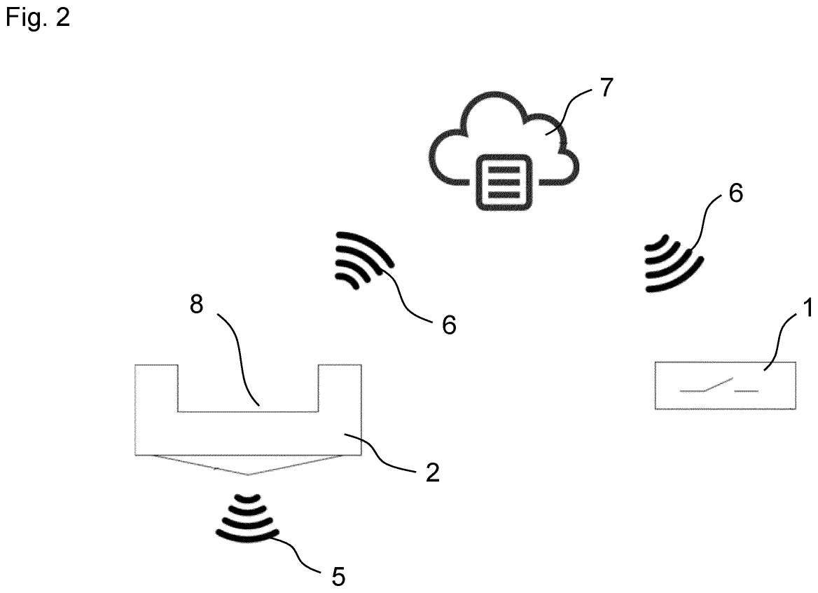

FIG. 2 a first arranging option of the function interface and the sensor of FIG. 1,

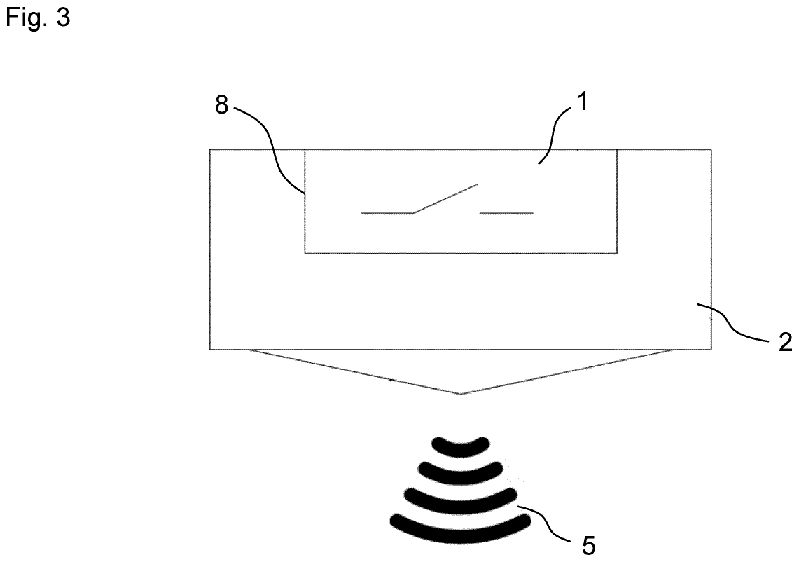

FIG. 3 a second arranging option of the function interface and the sensor of FIG. 1,

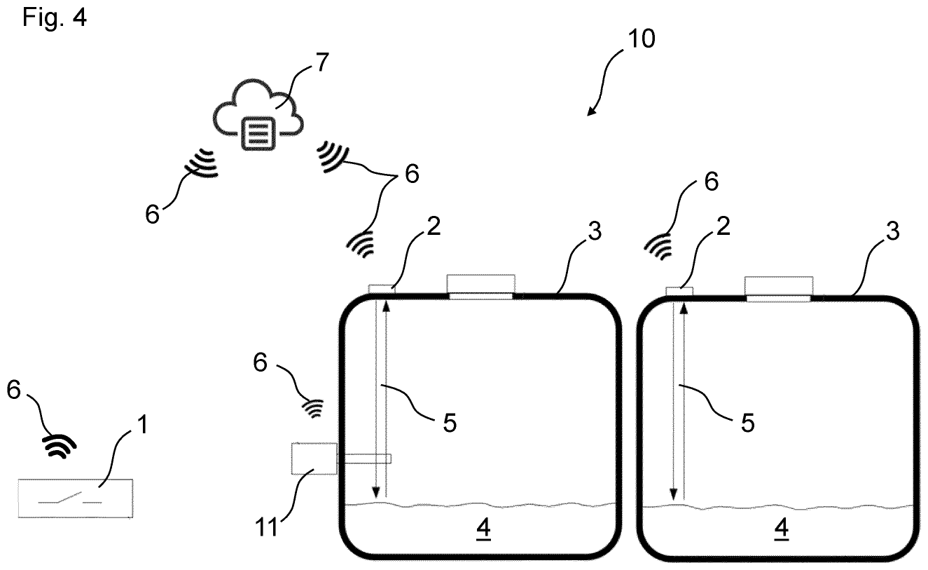

FIG. 4 an exemplary embodiment of an assembly consisting of one function interface and several sensors according to the invention,

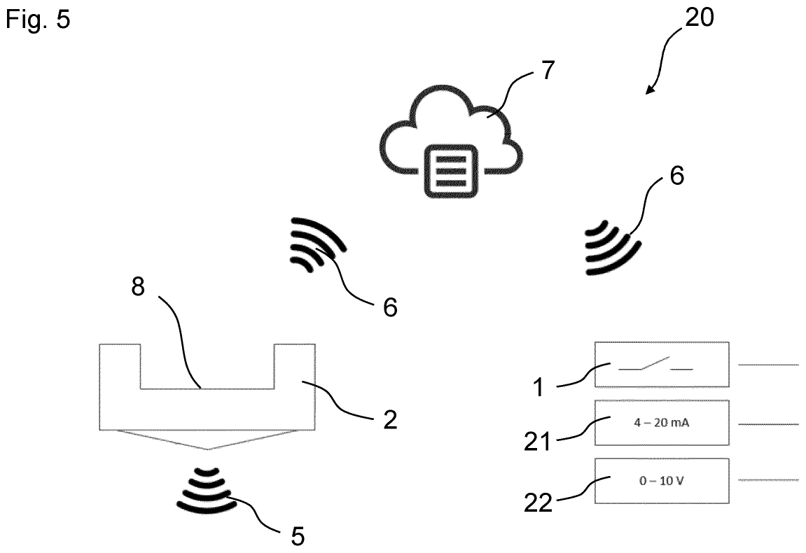

FIG. 5 an exemplary embodiment of an assembly consisting of several function interfaces and one sensor according to the invention,

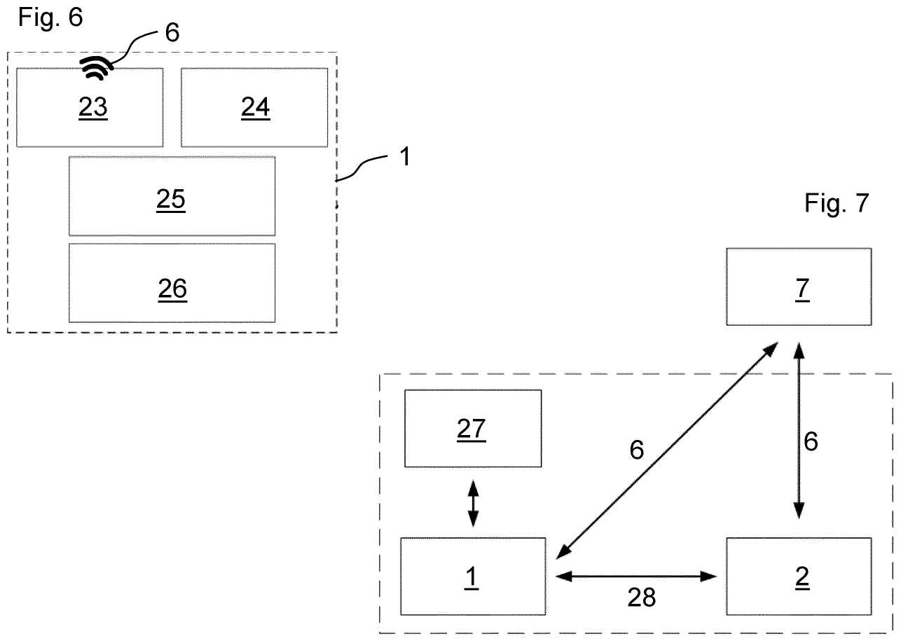

FIG. 6 a function diagram of an exemplary embodiment of an electronic function interface according to the invention, and

FIG. 7 a communication diagram of an exemplary assembly consisting of an electronic function interface and an electronic sensor according to the invention.

In the various figures, parts that are equivalent with respect to their function are always provided with the same reference numerals, so that they are also only described once, as a rule.

FIG. 1 illustrates a first example of use of an exemplary embodiment of, in each case, one electronic function interface 1 and one electronic sensor 2 according to the invention. In the present example, the sensor 2 is a radar sensor, without, however, being strictly limited thereto. The electronic sensor could also be a pressure sensor, for instance. The sensor 2 is disposed on a container 3 in order to detect by means of radar waves 5 a filling level (measured quantity) of a medium 4 accommodated therein.

FIG. 1 shows that the sensor 2 and the function interface 1 cooperate in a wirelessly data-transmitting manner, with the function interface 1 being configured as a unit that is constructionally independent of the sensor 2 and, as shown in FIG. 1, is operated in a location segregated from the sensor 2. The electronic function interface 1 provides at least one predetermined function depending on sensor information (i.e. sensor-related information, such as, for example, type of sensor, type of measured quantity, measurement range, reliability of measurement, amplitude, frequency etc.) and/or measurement values of the measured quantity (in the present case a filling level) detected by the sensor. The measurement values or information thereon are transmitted by means of the wireless data transmission 6 from the sensor 2 to the function interface 1.

Depending on the received measurement value information, the function interface 1 provides a function, which in the depicted exemplary embodiment is configured, for example, as a switching module with a switch output terminal. Thus, the function interface 1 is able to provide a switching state, e.g. closed or open, depending, for example, on predefined filling levels detected by the sensor 2.

In the example shown in FIG. 1, the wireless data transmission 6 is configured as a data transmission between the sensor 2 and the function interface 1 routed via an interposed device 7, which is external to the sensor and external to the function interface and which is represented in the present case as a “cloud”. Thus, data transmission does not take place directly between the sensor 2 and the function interface. The “cloud” 7 may be configured as a general data storage device, e.g. a data server or the like, and/or as a control/monitoring server of a higher-level control level of a measuring system (not shown).

FIG. 2 shows a first arranging option of the function interface 1 and the sensor 2 of FIG. 1. As can also be seen in FIG. 1, the function interface in FIG. 2 is spatially segregated from the sensor 2 and is communicatively connected thereto via the wireless data transmission 6.

Moreover, a holding device 8 of the sensor 2 can be seen in FIG. 2. The function interface 1 can be attached to the holding device 8. However, this is not the case in the arranging option depicted in FIG. 2, so that the holding device 8 of the sensor 2 provides a free interface site. It is to be understood that, of course, the holding device 8 of the sensor 8 is not absolutely required to be present in order to realize the arranging option shown in FIG. 2. The sensor 2 could also be provided without the holding device 8.

FIG. 3 shows a second arranging option of the function interface 1 and the sensor 2 of FIG. 1, in which the function interface 1 is now accommodated in the holding device 8 of the sensor 2 and is attached to the sensor 2. It is to be understood that the sensor 2 and the function interface 1 do not form an integral unit in this case. The function interface 1 is detachably attached to the holding device. The function interface 1 may also be replaced with another function interface (not shown), for instance.

FIG. 4 shows an exemplary embodiment of an assembly 10 consisting of one function interface, e.g. the function interface 1 of FIG. 1, and several sensors according to the invention, e.g. two radar sensors 2 from FIG. 1 and one limit level sensor 11. In the assembly 10 shown in FIG. 4, the function interface 1 is also configured as a unit that is constructionally independent of and segregable from the sensors 2 and 11. The function interface 1 is connected to the sensors 2 and 11 via the interposed device 7, in each case in a wirelessly data-transmitting manner. The assembly 10 substantially differs from the assembly shown in FIG. 1 only in that several sensors 2 and 11 are provided, which are jointly coupled to one and the same function interface 1 in the wirelessly data-transmitting manner, wherein the function interface 1 provides the at least one predetermined function depending on the sensor information and/or the measurement values of the measured quantities respectively detected by the two sensors 2 and the sensor 11.

FIG. 5 shows an exemplary embodiment of an assembly 20 consisting of several function interfaces 1, 21, 22 and one sensor according to the invention, in the present case the sensor 2 from FIG. 1, for example. In contrast to the assembly from FIG. 4, several function interfaces 1, 21, 22 are provided here, which are jointly coupled to one and the same sensor 2 in the wirelessly data-transmitting manner, wherein the function interfaces 1, 21, 22 respectively provide the at least one predetermined function depending on the sensor information and/or the measurement values of the measured quantity detected by the sensor 2 (in the present case a filling level). For this purpose, the function interface 1 has the switch output terminal as in FIG. 1. In the example shown, the function interface 21 has a current output terminal 4-20 mA. The function interface 22 has a voltage output terminal V. Other function output terminals are also conceivable.

FIG. 6 shows a function diagram of an exemplary embodiment of an electronic function interface according to the invention, e.g. the function interface 1 from FIG. 1. It is to be understood that the function interfaces 21 and 22 may also have the basic structure shown in FIG. 6. However, they may also deviate therefrom.

It can be seen in FIG. 6 that the function interface has a wireless data transmitting device 23 enabling a wireless data transmission 6, and also an electric energy storage unit 24 (e.g. a battery or rechargeable battery) providing a current supply of the function interface 1, and an electronic control system 25 (e.g. a computing and storage unit, such as a microcontroller) for controlling the interface function of the function interface 1, and finally a switching module 26 for providing the switch output terminal.

FIG. 7 shows a communication diagram of an exemplary assembly consisting of an electronic function interface, e.g. the function interface 1 from FIG. 1, and an electronic sensor according to the invention, e.g. the sensor 2 from FIG. 1. In FIG. 7, it can be seen that a control unit 27, which carries out a control process depending on the switching state of the switch output terminal of the function interface 1, is connected to the function interface 1, e.g. on the switch output terminal provided by the function interface 1. In the case shown in FIG. 7, the function interface 1 is communicatively connected to the sensor 2 via the wireless data transmission 6 by means of the interposed device 7. In addition, FIG. 7 also illustrates that, alternatively or additionally, a direct wireless communication 28 between the function interface 1 and the sensor 2 also may be possible, depending on the specific configuration.

The electronic function interface according to the invention, the electronic sensor and the assembly consisting of the function interface and the sensor disclosed herein are not limited to the embodiments respectively disclosed herein, but in each case also include further embodiments having the same effects, which result from technically viable other combinations of the features of the function interface, the sensor and the assembly described herein. In particular, the features and combinations of features mentioned above in the general description and the description of the Figures and/or shown in the Figures alone can be used not only in the combinations explicitly specified herein, but also in other combinations or on their own, without departing from the scope of the present invention.

In a preferred embodiment, the electronic function interface is used in combination with an electronic sensor for detecting a filling level and/or limit level and/or pressure (accordingly, with a filling level, limit level or pressure sensor) of a medium, wherein the function interface provides at least one predetermined function depending on sensor information and/or measurement values of the filling and/or limit level detected by the sensor.

### REFERENCE SIGNS LIST

1 Function interface
2 Sensor
3 Container
4 Medium
5 Radar waves
6 Indirect wireless data transmission
7 Interposed device/cloud
8 Holding device
10 Assembly
11 Limit level sensor
20 Assembly
21 Function interface
22 Function interface
23 Wireless data transmitting device
24 Energy storage unit
25 Electronic control system
26 Switching module
27 Control unit
28 Direct wireless data transmission

1. An electronic function interface, which cooperates with at least one electronic sensor for detecting a measured quantity, providing at least one predetermined function depending on sensor information and/or measurement values of the measured quantity detected by the sensor, wherein the function interface is a unit constructionally independent of and segregable from the sensor, and is coupled to the sensor in a wirelessly data-transmitting manner.

2. The function interface according to the preceding claim, further comprising at least one switch output terminal, current output terminal, voltage output terminal and/or a communications module providing the predetermined function.

3. The function interface according to claim 1, further comprising at least one electric energy storage unit and/or an electric energy supply device and/or an electric energy generator providing a current supply to the function interface.

4. The function interface according to claim 3, wherein the energy supply device has a wired coupling, which transmits electric energy, from a current feed from outside the function interface, and/or has a wireless coupling, which transmits electric energy, from a current feed from outside the function interface, and/or has an energy generating device for a current generation and current feed into the energy storage unit internal to the function interface.

5. The function interface according to claim 3, wherein the electric energy storage unit is a rechargeable energy storage unit that can be recharged repeatedly via the energy supply device and/or the energy generator.

6. The function interface according to claim 1, wherein the function interface is selectively activated in a permanent or cyclic or event-based manner.

7. The function interface according to claim 1, wherein the wireless data transmission is a unidirectional data transmission from the sensor to the function interface.

8. The function interface according to claim 1, wherein the wireless data transmission is a bidirectional data transmission between the sensor and the function interface.

9. The function interface according to claim 1, wherein the wireless data transmission is a direct data transmission between the sensor and the function interface and/or is an indirect data transmission between the sensor and the function interface routed via at least one interposed device that is external to the function interface and external to the sensor.

10. An electronic sensor for detecting a measured quantity, which cooperates with at least one electronic function interface for providing at least one predetermined function depending on sensor information and/or measurement values of the measured quantity detected by the sensor, wherein the sensor is a unit constructionally independent of and segregable from the function interface, and coupled to the function interface in a wirelessly data-transmitting manner.

11. The sensor according to claim 10, further comprising a holding device to which the function interface can be attached.

12. The sensor according to claim 10, further comprising a coupling means, which transmits electric energy and provides a current supply for the function interface attached to the holding device.

13. The sensor according to claim 12, wherein the coupling means transmits energy to the function interface in a wired manner or in a wireless manner.

14. The sensor according to claim 10, wherein the wireless data transmission is a unidirectional data transmission from the sensor to the function interface.

15. The sensor according to claim 10, wherein the wireless data transmission is a bidirectional data transmission between the sensor and the function interface.

16. The sensor according to claim 10, wherein the wireless data transmission is a direct data transmission between the sensor and the function interface and/or is an indirect data transmission between the sensor and the function interface routed via at least one interposed device that is external to the sensor and external to the function interface.

17. The sensor according to claim 10, wherein the sensor is a limit level sensor, a pressure sensor or a filling level sensor.

18. An assembly of comprising
a. an electronic sensor detecting a measured quantity, and
b. an electronic function interface which cooperates with said electronic sensor, providing at least one predetermined function depending on sensor information and/or measurement values of the measured quantity detected by the sensor,
c. wherein the function interface is a unit constructionally independent of and segregable from the sensor, and is coupled to the sensor in a wirelessly data-transmitting manner.

19. The assembly according to claim 18, further comprising at least a second sensor for detecting a second measured quantity, said sensors jointly coupled to said electronic function interface in the wirelessly data-transmitting manner, wherein the function interface provides the at least one predetermined function depending on the sensor information and/or the measurement values of the measured quantities respectively detected by the sensors.

20. The assembly according to claim 18, further comprising at least a second function interface providing at least a second predetermined function, jointly coupled to said sensor in the wirelessly data-transmitting manner, wherein the function interfaces respectively provide the at least one and second predetermined function depending on the sensor information and/or the measurement values of the measured quantities detected by the sensor.
